(19) United States
(12) Patent Application Publication
(10) Pub. No.: US 2009/0241811 A1
(43) Pub. Date: Oct. 1, 2009

(54) COLLAPSIBLE TABLE

(76) Inventors: Harvey K. Markegard, Billings, MT (US); Chen Li Bin, Changzhou (CN); Li Jian An, Changzhou (CN)

Correspondence Address: ANTOINETTE M. TEASE, P. O. BOX 51016, BILLINGS, MT, 59105, US

(21) Appl. No.: 12/056,986

(22) Filed: Mar. 27, 2008

(51) Int. Cl. A47B 3/02; A47B 3/12; F16M 11/38

(52) U.S. Cl. 108/118; 108/159; 248/188.6

(57) ABSTRACT

A collapsible table comprising a table top that is both removable and foldable and a leg assembly that is fully collapsible and that comprises six sliding points. The table top attaches to the leg assembly by inserting hooks on horizontal arms of the leg assembly into apertures on the side surfaces of the folding table top and then pressing the table top flat onto the leg assembly.

### BACKGROUND OF THE INVENTION

1. Field of the Invention

The present invention relates generally to the field of portable furniture, and more specifically, to a collapsible, light-weight portable table.

2. Description of the Related Art

Portable tables have a variety of uses, from hunting, fishing and camping to tailgate parties, baseball games, etc. Collapsible tables are particularly useful for these situations because they take up less space in transport and are easily portable. Light-weight tables are desirable because they can be carried in backpacks or bags. Prior art includes a number of collapsible tables and stands, but none of them with the unique design features of the present invention.

Examples of prior art collapsible tables include U.S. Pat. No. 7,131,364 (Brazell, 2006); U.S. Pat. No. 6,792,880 (Tsai, 2004); U.S. Pat. No. 6,640,730 (Tsai, 2003); U.S. Pat. No. 5,645,259 (Chen, 1997); U.S. Pat. No. 2,638,394 (Ulrich, 1953); U.S. Pat. No. 1,295,194 (Parelius, 1919); and U.S. Patent Application Pub. No. 2004/0051009 (Chen). Examples of collapsible frames include U.S. Pat. No. 6,929,230 (Tsai, 2005); U.S. Pat. No. 6,073,894 (Chen, 2000); and U.S. Patent Application Pub. No. 2004/0084581 (Chang).

None of the above inventions has the same leg assembly design as the present invention. In addition, none of the above inventions has a table top that attaches in the same manner as the table top of the present invention.

What is needed is a light-weight, collapsible, portable table that is attractive, stable and easy to use. Specifically, the legs must be easy to collapse, and the table top must be easy to install and remove. The present invention provides these features.

### BRIEF SUMMARY OF THE INVENTION

The present invention is a collapsible table comprising a table top and a leg assembly; wherein the table top is foldable along a center hinge; wherein the table top comprises two halves formed by the center hinge, wherein each half of the table top comprises a side surface, and wherein each side surface of each half of the table top comprises two apertures for receiving hooks on the leg assembly; wherein the leg assembly comprises a first horizontal arm and a second horizontal arm; wherein the first and second horizontal arms each comprises two hooks; wherein the apertures on the side surfaces of the table top are slightly larger than the hooks; wherein the hooks are configured so as to fit into the apertures on the side surfaces of the table top; wherein to install the table top on the leg assembly, the hooks are inserted into the apertures on the side surfaces of the table top, and the table top is pressed flat; wherein the table top comprises an underside; and wherein the first and second horizontal arms of the leg assembly fit into channels formed by ridges on the underside of the table top when the table top is pressed flat onto the leg assembly with the hooks inserted into the apertures on the table top.

In a preferred embodiment, the leg assembly comprises a first vertical bar, a second vertical bar, a third vertical bar, and a fourth vertical bar; the leg assembly further comprises a first primary cross-bar, a second primary cross-bar, a third primary cross-bar, and a fourth primary cross-bar; the leg assembly further comprises a first secondary cross-bar, a second secondary cross-bar, a third secondary cross-bar, and a fourth secondary cross-bar; the first vertical bar comprises a top end and a bottom end; the first primary cross-bar comprises a bottom half; the bottom end of the first vertical bar is pivotally attached to the bottom half of the first primary cross-bar; the top end of the first vertical bar is slidably attached to the first horizontal arm; the third vertical bar comprises a top end and a bottom end; the third primary cross-bar comprises a bottom half; the bottom end of the third vertical bar is pivotally attached to the bottom half of the third primary cross-bar; the top end of the third vertical bar is slidably attached to the second horizontal arm; the second vertical bar comprises a top end and a bottom end; the first and second primary cross-bars are pivotally attached to each other at a point; the bottom end of the second vertical bar is pivotally and slidably attached to the second primary cross-bar below the point at which the first and second primary cross-bars are pivotally attached to each other; the top end of the second vertical bar is fixedly attached to a first extension piece; the first extension piece is pivotally attached to the first horizontal arm; the fourth vertical bar comprises a top end and a bottom end; the third and fourth primary cross-bars are pivotally attached to each other at a point; the bottom end of the fourth vertical bar is pivotally and slidably attached to the fourth primary cross-bar below the point at which the third and fourth primary cross-bars are pivotally attached to each other; the top end of the fourth vertical bar is fixedly attached to a second extension piece; the second extension piece is pivotally attached to the second horizontal arm; the first and second primary cross-bars each has a bottom end and a top end; the bottom end of the first primary cross-bar comprises a foot piece; the first and second vertical bars each comprises a center; the top end of the first primary cross-bar is pivotally attached to roughly the center of the second vertical bar; the bottom end of the second primary cross-bar comprises a foot piece; the second secondary cross-bar comprises a top end; the top end of the second primary cross-bar is pivotally and slidably attached to roughly the center of the first vertical bar and pivotally attached to the top end of the second secondary cross-bar; the first and second primary cross-bars each comprises a middle third; the first and second primary cross-bars are pivotally attached to each other in the middle third of each of these two primary cross-bars; the third and fourth primary cross-bars each has a bottom end and a top end; the bottom end of the third and fourth primary cross-bars each comprises a foot piece; the third and fourth vertical bars each comprises a center; the top end of the third primary cross-bar is pivotally attached to roughly the center of the fourth vertical bar; the fourth secondary cross-bar comprises a top end; the top end of the fourth primary cross-bar is pivotally and slidably attached to roughly the center of the third vertical bar and pivotally attached to the top end of the first secondary cross-bar; the third and fourth primary cross-bars each comprises a middle third; the third and fourth primary cross-bars are pivotally attached to each other in the middle third of each of these two primary cross-bars; the first secondary cross-bar comprises a bottom end and a top end; the second secondary cross-bar further comprises a bottom end; the first primary cross-bar comprises a bottom third; the bottom end of the first secondary cross-bar is fixedly attached to the bottom third of the first primary cross-bar; the top end of the first secondary cross-bar is pivotally attached to the top end of the fourth primary cross-bar; the third primary cross-bar comprises a bottom third; the bottom end of the second secondary cross-bar is fixedly attached to the bottom third of the third primary cross-bar; the top end of the second secondary cross-bar is pivotally attached to the top end of the second primary cross-bar; the first and second secondary cross-bars each comprises a center; the first and second secondary cross-bars are pivotally attached to each other at roughly the center of each of these two secondary cross-bars; the third secondary cross-bar comprises a bottom end and a top end; the fourth secondary cross-bar further comprises a bottom end; the fourth primary cross-bar comprises a bottom third; the bottom end of the third secondary cross-bar is fixedly attached to the bottom third of the fourth primary cross-bar; the top end of the third secondary cross-bar is pivotally attached to the second vertical bar at roughly the center of the second vertical bar; the second primary cross-bar comprises a bottom third; the bottom end of the fourth secondary cross-bar is fixedly attached to the bottom third of the secondary primary cross-bar; the top end of the fourth secondary cross-bar is pivotally attached to the fourth vertical bar at roughly the center of the fourth vertical bar; the third and fourth secondary cross-bars each comprises a center; and the third and fourth secondary cross-bars are pivotally attached to each other at roughly the center of each of these two secondary cross-bars.

In a preferred embodiment, each of the first and second horizontal arms comprises two ends; one end of the first horizontal arm is pivotally attached to the first extension piece at a point; the other end of the first horizontal arm is slidably attached to the top end of the first vertical bar; one end of the second horizontal arm is pivotally attached to the second extension piece at a point; and the other end of the second horizontal arm is slidably attached to the top end of the third vertical bar.

In a preferred embodiment, the bottom ends of the first and third vertical bars are pivotally attached to the first and third primary cross-bars with brackets that are fixedly attached to the first and third primary cross-bars and that allow the bottom ends of the first and third vertical bars to pivot in relation to the first and third primary cross-bars.

In a preferred embodiment, the bottom end of the second vertical bar is pivotally and slidably attached to the second primary cross-bar with a bracket that moves slidably up and down on the second primary cross-bar and that allows the bottom end of the second vertical bar to pivot in relation to the bracket; and the bottom end of the fourth vertical bar is pivotally and slidably attached to the fourth primary cross-bar with a bracket that moves slidably up and down on the fourth primary cross-bar and that allows the bottom end of the fourth vertical bar to pivot in relation to the bracket.

In a preferred embodiment, the leg assembly further comprises a bracket that allows the top end of the second primary cross-bar to slide upward on the first vertical bar when the leg assembly is collapsed and to slide downward on the first vertical bar when the leg assembly is extended from a collapsed position and that allows the top end of the second primary cross-bar to pivot in relation to the bracket; and the leg assembly further comprises a bracket that allows the top end of the fourth primary cross-bar to slide upward on the third vertical bar when the leg assembly is collapsed and to slide downward on the third vertical bar when the leg assembly is extended from a collapsed position and that allows the top end of the fourth primary cross-bar to pivot in relation to the bracket.

In a preferred embodiment, the first extension piece comprises a channel for receiving the first horizontal arm when the leg assembly is fully extended; and the second extension piece comprises a channel for receiving the second horizontal arm when the leg assembly is fully extended.

In a preferred embodiment, the first and second horizontal arms each comprises a rear end; when the leg assembly is partially or fully collapsed, the rear end of each horizontal arm pivots out of the channel in the extension piece and extends upward; each channel comprises a front end; the point at which the first horizontal arm is pivotally attached to the first extension piece is located on the front end of the channel in the first extension piece; and the point at which the second horizontal arm is pivotally attached to the second extension piece is located on the front end of the channel in the second extension piece.

In a preferred embodiment, the top end of the first vertical bar is connected to the first horizontal arm with a sliding bracket and the top end of the third vertical bar is connected to the second horizontal arm with a sliding bracket; the sliding brackets are constructed so that when the leg assembly is collapsed, the top end of the first vertical bar slides along the first horizontal arm from front to back and the top end of the third vertical bar slides along the second horizontal arm from front to back, and when the leg assembly is extended, the top end of the first vertical bar slides along the first horizontal arm from back to front and the top end of the third vertical bar slides along the second horizontal arm from back to front; and the sliding brackets are constructed so that the horizontal bars will not pivot out of them when the leg assembly is collapsed or extended but will remain lodged inside the sliding brackets at all times.

In a preferred embodiment, the extension pieces and sliding brackets are all on a single horizontal plane when the leg assembly is fully extended; and the horizontal arms are designed so that no part of the horizontal arms extends above the horizontal plane of the extension pieces and sliding brackets when the leg assembly is fully extended.

### BRIEF DESCRIPTION OF THE DRAWINGS

FIG. 1 is a perspective view of the present invention with the table top installed.

FIG. 2 is a perspective view of the present invention with the table top removed.

FIG. 3 is a side view of the present invention with the table top removed.

FIG. 4 is a front view of the present invention with the table top removed.

FIG. 5 is a top view of the present invention with the table top removed.

FIG. 6 is a bottom view of the present invention with the table top removed.

FIG. 7 is a perspective view of the present invention with the table top removed and the leg assembly partially collapsed.

FIG. 8 is a perspective view of the present invention with the table top removed and the leg assembly completely collapsed.

FIG. 9 is a side view of the present invention with the table top removed and the leg assembly completely collapsed.

FIG. 10 is a front view of the present invention with the table top removed and the leg assembly completely collapsed.

FIG. 11 is a top view of the present invention with the table top removed and the leg assembly completely collapsed.

FIG. 12 is a bottom view of the present invention with the table top removed and the leg assembly completely collapsed.

FIG. 13 is a bottom view of the table top of the present invention.

FIG. 14 is a perspective view of the table top of the present invention with the table top partially folded.

FIG. 15 is a perspective view of the present invention with the table top installed shown with an optional hanging mesh bag.

FIG. 16 is a perspective view of the present invention with the table top installed shown with an optional waterproof bag.

### REFERENCE NUMBERS

1 Table top
2 Leg assembly
3 Center hinge (of table top)
4 Aperture (on side of table top)
5 Hook (on horizontal arm of leg assembly)
6 First horizontal arm (of leg assembly)
6a Second horizontal arm (of leg assembly)
7 Channel (on underside of table top)
8 First vertical bar
9 Second vertical bar
10 Third vertical bar
11 Fourth vertical bar
12 First primary cross-bar
13 Second primary cross-bar
14 Third primary cross-bar
15 Fourth primary cross-bar
16 First secondary cross-bar
17 Second secondary cross-bar
18 Third secondary cross-bar
19 Fourth secondary cross-bar
20 First extension piece
20a Second extension piece
21 Foot piece
22 Bracket (pivot)
23 Sliding/pivot bracket (bottom ends of second and fourth vertical bars to second and fourth primary cross-bars)
Sliding/pivot bracket (top end of second primary cross-bar to first vertical bar and top end of fourth primary cross-bar to third vertical bar)
Channel (in extension piece)
Pivot point (horizontal arm and extension piece)
Sliding bracket (horizontal arms to top ends of first and third vertical bars)
Mesh bag
VELCRO® strips
Waterproof bag

### DETAILED DESCRIPTION OF INVENTION

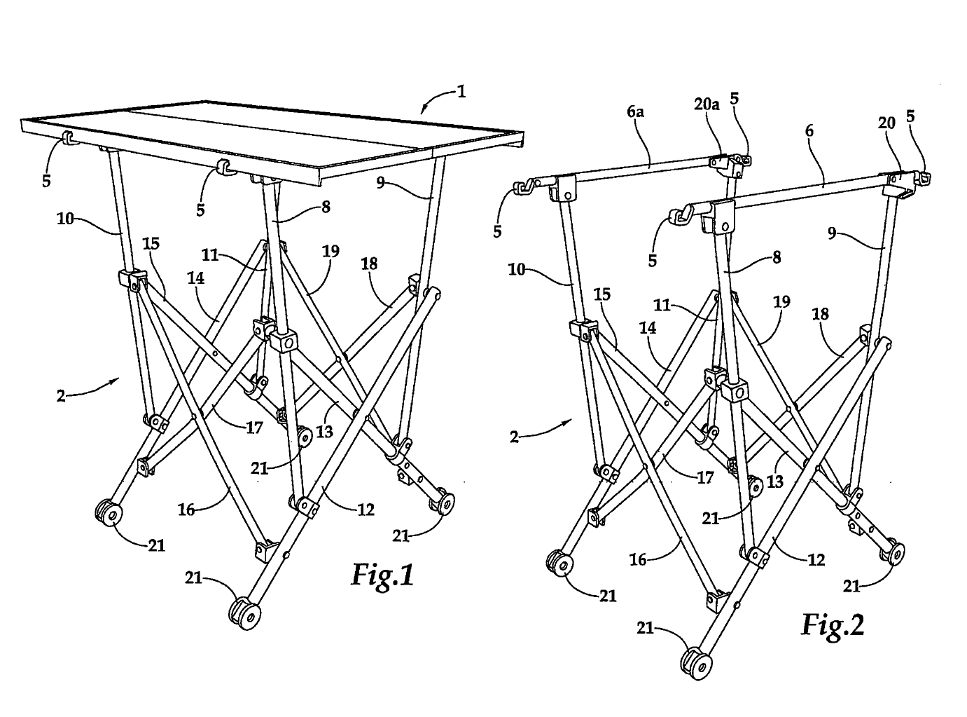

FIG. 1 is a perspective view of the present invention with the table top installed. As shown in this figure, the present invention comprises a removable table top 1 and a leg assembly 2. As shown in this and subsequent figures, the table top 1 is foldable along a center hinge 3, and each half of the table top 1 comprises apertures 4 (see FIG. 14) on the side surface that are slightly larger than the hooks 5 on the ends of the two horizontal arms 6, 6a of the leg assembly 2. To install the table top 1 on the leg assembly 2, the hooks 5 are inserted into the apertures 4 on the folding table top, and the table top is pressed flat. The horizontal arms 6, 6a of the leg assembly 2 fit into channels 7 formed by ridges on the underside of the table top 1 (see FIGS. 13 and 14) when the table top is pressed flat onto the leg assembly with the hooks 5 inserted into the apertures 4 on the table top. These channels ensure that the table top will remain stable when it is installed on the leg assembly.

FIG. 2 is a perspective view of the present invention with the table top removed. As shown in this figure, the leg assembly 2 comprises a first vertical bar 8, a second vertical bar 9, a third vertical bar 10, and a fourth vertical bar 11. The leg assembly further comprises a first primary cross-bar 12, a second primary cross-bar 13, a third primary cross-bar 14, and a fourth primary cross-bar 15. In addition, the leg assembly comprises a first secondary cross-bar 16, a second secondary cross-bar 17, a third secondary cross-bar 18, and a fourth secondary cross-bar 19.

The first vertical bar 8 comprises a top end and a bottom end. The bottom end of the first vertical bar 8 is pivotally attached to the bottom half of the first primary cross-bar 12. The top end of the first vertical bar 8 is slidably attached to the first horizontal arm 6. Similarly, the third vertical bar 10 comprises a top end and a bottom end. The bottom end of the third vertical bar 10 is pivotally attached to the bottom half of the third primary cross-bar 14. The top end of the third vertical bar 10 is slidably attached to the second horizontal arm 6a.

The second vertical bar 9 also comprises a top end and a bottom end. The bottom end of the second vertical bar 9 is pivotally and slidably attached to the second primary cross-bar 13 below the point at which the first and second primary cross-bars 12, 13 are pivotally attached to each other. The top end of the second vertical bar 9 is fixedly attached to a first extension piece 20, which in turn is pivotally attached to the first horizontal arm 6. Similarly, the fourth vertical bar 11 comprises a top end and a bottom end. The bottom end of the fourth vertical bar 11 is pivotally and slidably attached to the fourth primary cross-bar 15 below the point at which the third and fourth primary cross-bars 14, 15 are pivotally attached to each other. The top end of the fourth vertical bar 11 is fixedly attached to a second extension piece 20a, which in turn is pivotally attached to the second horizontal arm 6a.

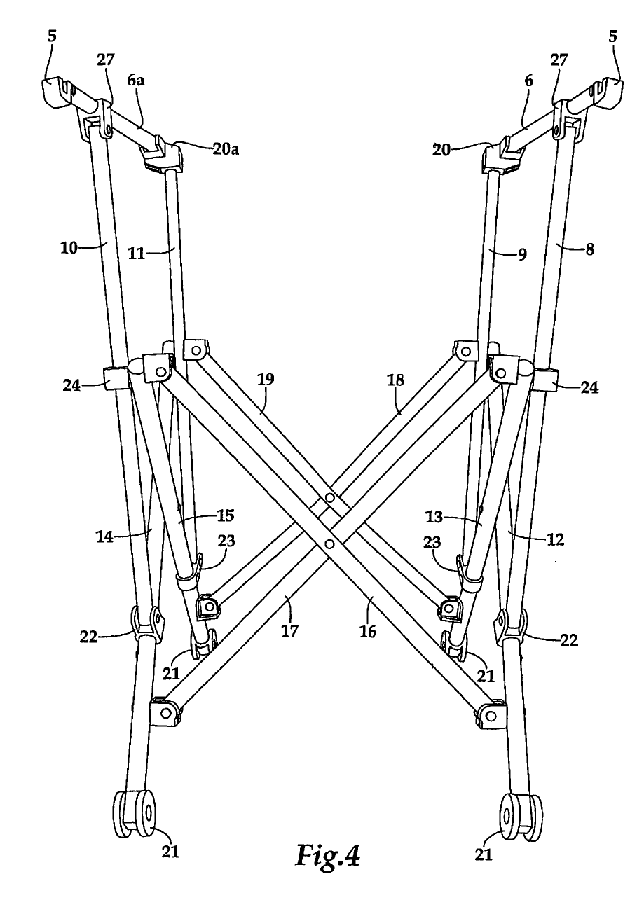

The first and second primary cross-bars 12, 13 each has a bottom end and a top end. The bottom end of the first primary cross-bar 12 comprises a foot piece 21. The top end of the first primary cross-bar 12 is pivotally attached to roughly the center of the second vertical bar 9. Similarly, the bottom end of the second primary cross-bar 13 comprises a foot piece 21. The top end of the second primary cross-bar 13 is pivotally and slidably attached to roughly the center of the first vertical bar 8 and pivotally attached to the top end of the second secondary cross-bar 17 (this is shown better in FIG. 4). The first and second primary cross-bars 12, 13 each comprises a middle third (for example, if each primary cross-bar were divided into thirds length-wise, there would be a top third, a middle third and a bottom third), and the first and second primary cross-bars 12, 13 are pivotally attached to each other in the middle third of each primary cross-bar.

The third and fourth primary cross-bars 14, 15 each has a bottom end and a top end. The bottom end of the third primary cross-bar 14 comprises a foot piece 21. The top end of the third primary cross-bar 14 is pivotally attached to roughly the center of the fourth vertical bar 11. Similarly, the bottom end of the fourth primary cross-bar 15 comprises a foot piece 21. The top end of the fourth primary cross-bar 15 is pivotally and slidably attached to roughly the center of the third vertical bar 10 and pivotally attached to the top end of the fourth secondary cross-bar 15 (this is shown better in FIG. 4). The third and fourth primary cross-bars 14, 15 each comprises a middle third (for example, if each primary cross-bar were divided into thirds length-wise, there would be a top third, a middle third and a bottom third), and the third and fourth primary cross-bars 14, 15 are pivotally attached to each other in the middle third of each primary cross-bar.

The first and second secondary cross-bars 16, 17 each has a bottom end and a top end. The bottom end of the first secondary cross-bar 16 is fixedly attached to the bottom third of the first primary cross-bar 12. The top end of the first secondary cross-bar 16 is pivotally attached to the top end of the fourth primary cross-bar 15. Similarly, the bottom end of the second secondary cross-bar 17 is fixedly attached to the bottom third of the third primary cross-bar 14. The top end of the second secondary cross-bar 17 is pivotally attached to the top end of the second primary cross-bar 13. The first and second secondary cross-bars 16, 17 are pivotally attached to each other at roughly the center of each secondary cross-bar.

The third and fourth secondary cross-bars 18, 19 each has a bottom end and a top end. The bottom end of the third secondary cross-bar 18 is fixedly attached to the bottom third of the fourth primary cross-bar 15. The top end of the third secondary cross-bar 18 is pivotally attached to the second vertical bar 9 at roughly the center of the second vertical bar. Similarly, the bottom end of the fourth secondary cross-bar 19 is fixedly attached to the bottom third of the second primary cross-bar 13. The top end of the fourth secondary cross-bar 19 is pivotally attached to the fourth vertical bar 11 at roughly the center of the fourth vertical bar. The third and fourth secondary cross-bars 18, 19 are pivotally attached to each other at roughly the center of each secondary cross-bar.

The first and second horizontal arms 6, 6a each has a hook 5 on either end of the horizontal arm. The hooks 5 are configured so as to fit into the apertures 4 on the table top 1 (see FIGS. 1 and 14). One end of the first horizontal arm 6 is pivotally attached to the first extension piece 20, which in turn is fixedly attached to the top end of the second vertical bar 9. The other end of the first horizontal arm 6 is slidably attached to the top end of the first vertical bar 8. Similarly, one end of the second horizontal arm 6a is pivotally attached to the second extension piece 20a, which in turn is fixedly attached to the top end of the fourth vertical bar 11. The other end of the second horizontal arm 6a is slidably attached to the top end of the third vertical bar 10.

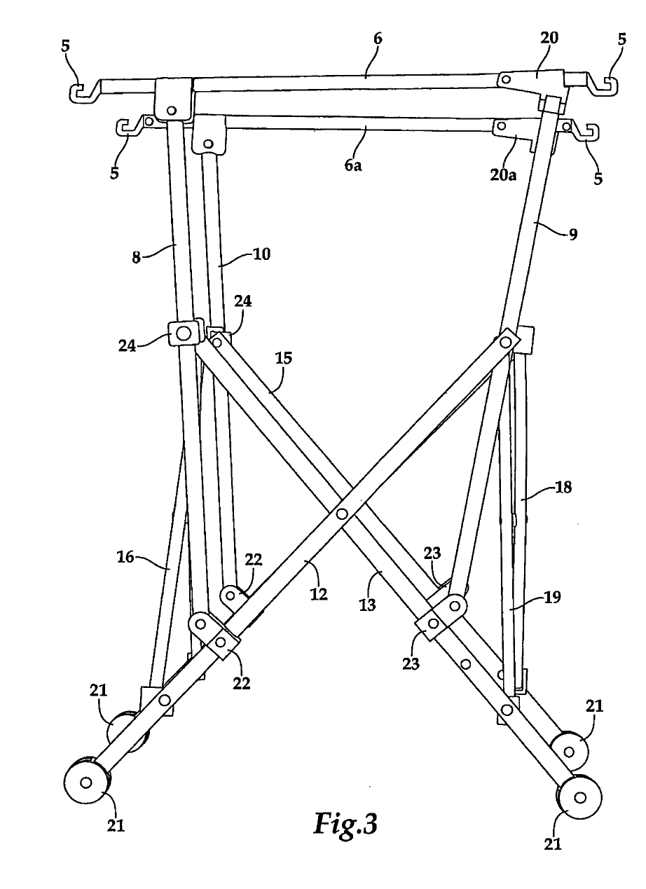

FIG. 3 is a side view of the present invention with the table top removed. As shown in this figure (and in FIGS. 1 and 2), one method of pivotally attaching the bottom ends of the first and third vertical bars 8, 10 to the first and third primary cross-bars 12, 14 is through the use of brackets 22 that are fixedly attached to the first and third primary cross-bars and that allow the bottom ends of the first and third vertical bars to pivot in relation to the first and third primary cross-bars.

The bottom ends of the second and fourth vertical bars 9, 11 are both pivotally and slidably attached to the second and fourth primary cross-bars 13, 15, respectively. One method of pivotally and slidably attaching the bottom ends of the second and fourth vertical bars 9, 11 to the second and fourth primary cross-bars 13, 15 is through the use of sliding/pivot brackets 23 that move slidably up and down on the second and fourth primary cross-bars 13, 15 and that allow the bottom ends of the second and fourth vertical bars 9, 11 to pivot in relation to the brackets 23.

FIGS. 3 and 4 also show the two sliding/pivot brackets 24 that are located roughly in the center of the first and third vertical bars 8, 10 when the leg assembly is fully extended (as shown in FIG. 3). These sliding/pivot brackets 24 allow the top end of the second primary cross-bar 13 and the top end of the fourth primary cross-bar 15 to slide upward on the first vertical bar 8 and third vertical bar 10, respectively, when the leg assembly is collapsed and to slide downward (to the center position) on the first vertical bar 8 and third vertical bar 10, respectively, when the leg assembly is extended from a collapsed position. The sliding/pivot brackets 24 also allow the top ends of the second and fourth primary cross-bars 13, 15 to pivot in relation to the brackets 24.

FIG. 4 is a front view of the present invention with the table top removed.

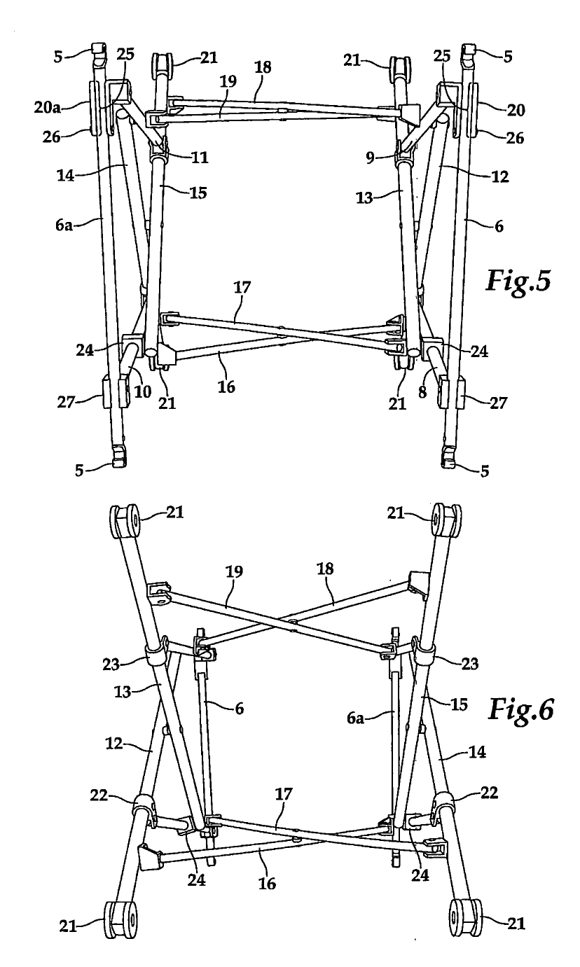

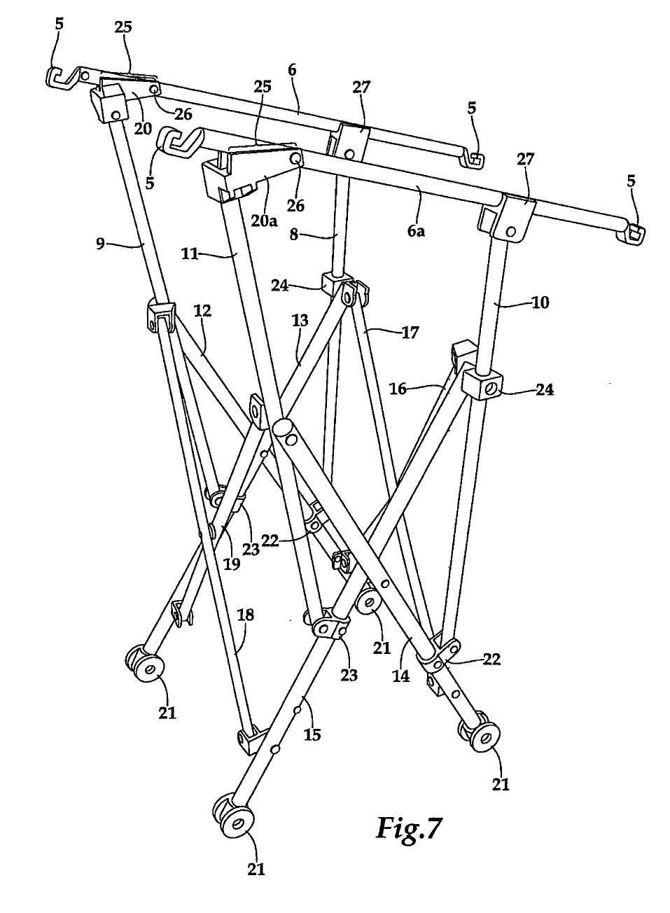

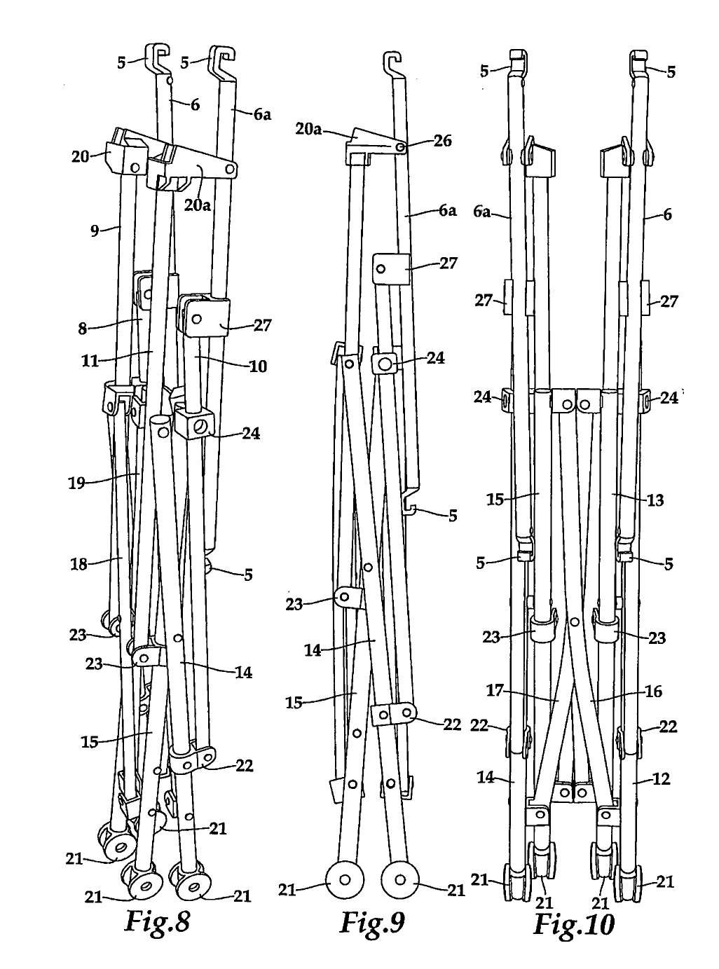

FIG. 5 is a top view of the present invention with the table top removed. As shown in this figure, the extension pieces 20, 20a are constructed so that the horizontal arms 6, 6a rest inside of a channel 25 in each extension piece when the leg assembly is fully extended (as shown in FIG. 5). When the leg assembly is partially or fully collapsed, the rear end of each horizontal arm pivots out of the channel 25 of the extension piece and extends upward (see FIGS. 7 and 8). The point at which the horizontal arms 6, 6a are pivotally attached to the extension pieces 20, 20a is located on the front end of the channel in each extension piece. This pivot point is indicated as reference number 26 on FIGS. 5 and 7.

Also shown in FIG. 5 are the sliding brackets 27 that connect the first and third vertical bars 8, 10 to the horizontal arms 6, 6a. These sliding brackets are constructed so that when the leg assembly is collapsed or extended, the top ends of the first and third vertical bars slide along the horizontal arms from front to back (to collapse the leg assembly) and vice versa (to extend the leg assembly). As illustrated in this figure, the sliding brackets 27 are constructed so that the horizontal bars will not pivot out of them when the leg assembly is collapsed or extended but will remain lodged inside the sliding brackets at all times. This can be accomplished by simply extending the top surface of the sliding brackets around and over the top of each horizontal arm, either partially (as shown in FIG. 5) or completely.

FIG. 6 is a bottom view of the present invention with the table top removed.

FIG. 7 is a perspective view of the present invention with the table top removed and the leg assembly partially collapsed. As described above, when the leg assembly begins to be collapsed, the horizontal arms 6, 6a pivot out of the channels 25 in the extension pieces 20, 20a. The pivot point 26 that joins the horizontal arms to the extension pieces must be located on the front of the extension piece (at the front of the channel) in order for this to work.

If FIG. 2 is compared to FIG. 7, it will become apparent that the table comprises six sliding points. The first two sliding points are located at the sliding brackets 27 on the horizontal arms 6, 6a. The next two sliding points are located at the sliding/pivot brackets 24 on the first and third vertical arms 8, 10. The last two sliding points are located at the sliding/pivot brackets 23 on the second and fourth primary cross-bars 13, 15. As shown in FIG. 7, as the leg assembly is collapsed, the sliding brackets 27 on the horizontal arms move rearward (toward the extension pieces 20, 20a), thereby causing the hooks 5 on the rear ends of the horizontal arms 6, 6a to pivot upward. The sliding/pivot brackets 24 on the first and third vertical bars 8, 10 move upward on the vertical bars, and the sliding/pivot brackets 23 on the second and fourth primary cross-bars 13, 15 also move upward (but no further than the point at which the first and second primary cross-bars 12, 13 and the third and fourth primary cross-bars 14, 15 are pivotally attached to each other).

FIGS. 8, 9 and 10 are a perspective view, a side view, and a front view, respectively, of the present invention with the table top removed and the leg assembly completely collapsed. As shown in these three figures, the design of the present invention allows the leg assembly 2 to be folded compactly so as to minimize space requirements when the table is not in use.

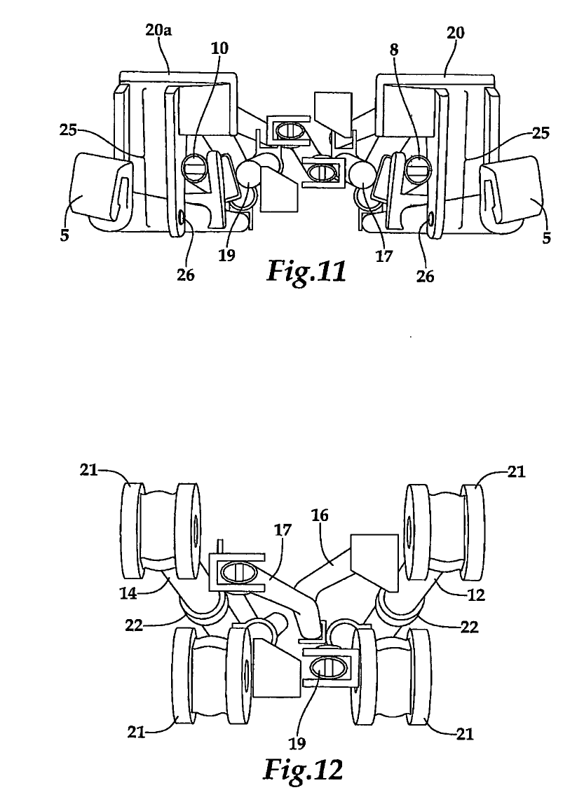

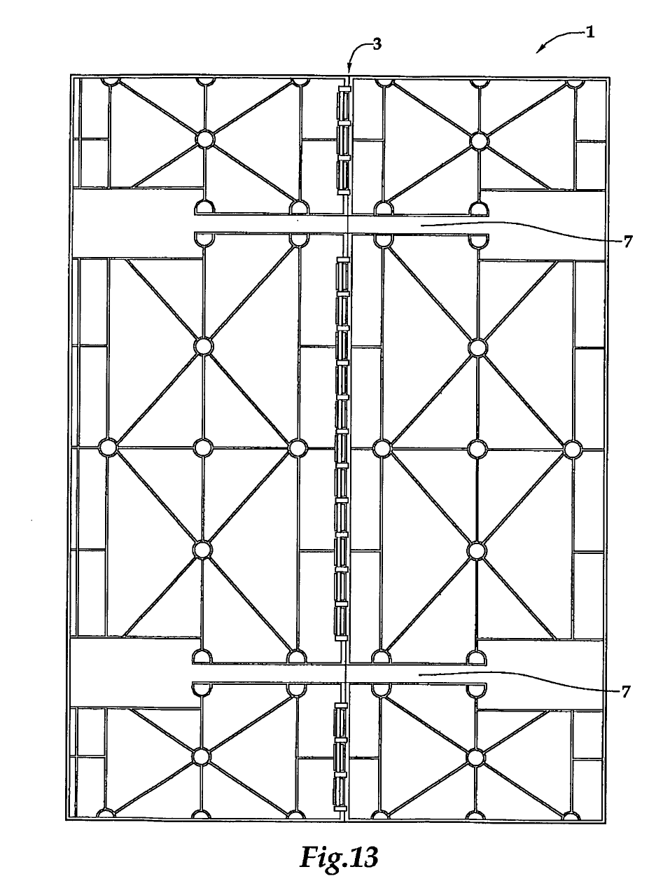

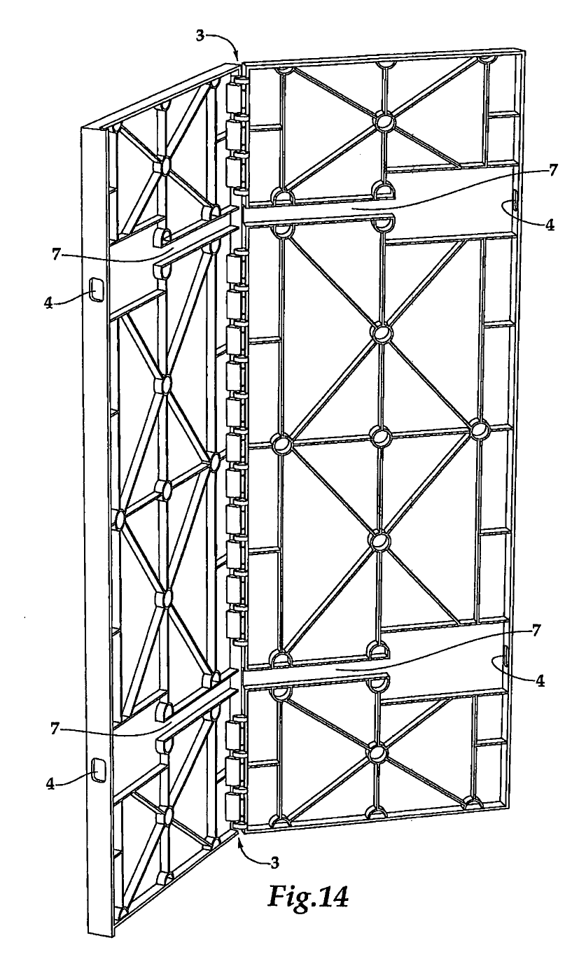

FIGS. 11 and 12 are top and bottom views, respectively, of the present invention with the table top removed and the leg assembly completely collapsed. Certain parts have been omitted for clarity. The purpose of these figures is to further illustrate the compact nature of the leg assembly when fully collapsed.

FIG. 13 is a bottom view of the table top of the present invention. This figure shows the center hinge 3 that allows the table top 1 to fold in half for installation and removal of the table top 1 on the leg assembly 2. It also shows the channels 7 into which the horizontal arms 6, 6a are inserted when the table top is placed on top of the leg assembly and pressed flat (with the hooks 5 inserted into the apertures 4 on the sides of the table top), as shown in FIG. 1. With the exception of the channels 7 for the horizontal arms, none of the ridges shown in this figure on the underside of the table top is significant in terms of the functionality of the present invention.

Referring to FIG. 3, the present invention is constructed so that the horizontal arms 6, 6a are perfectly horizontal when the leg assembly is fully extended. The horizontal arms themselves are designed so that no part of the horizontal arms extends above the extension pieces 20, 20a and the sliding brackets 27, which are on the same horizontal plane when the leg assembly is fully extended. (The rear ends of the horizontal arms do extend above the extension pieces 20, 20a when the table is partially or fully collapsed, as shown in FIGS. 7-10).

FIG. 14 is a perspective view of the table top of the present invention with the table top partially folded. This figure shows the apertures 4 into which the hooks 5 on the horizontal arms 6, 6a of the leg assembly are inserted when the table top is placed on top of the fully extended leg assembly and pressed flat (see FIG. 1).

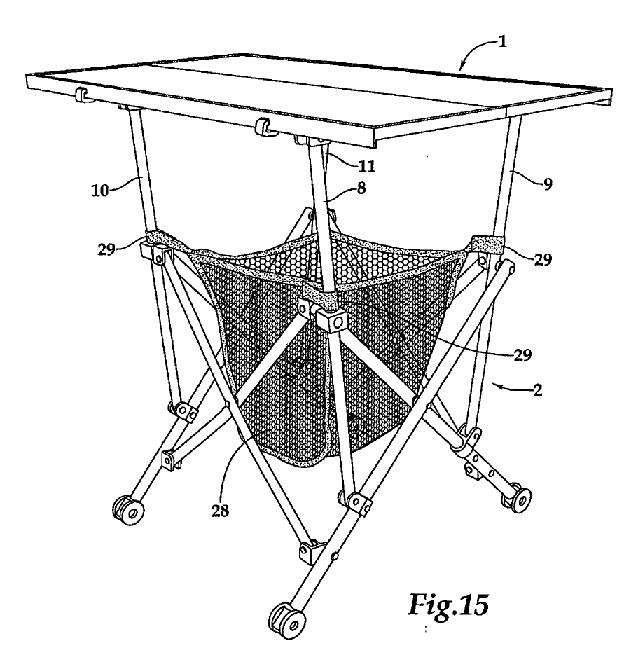

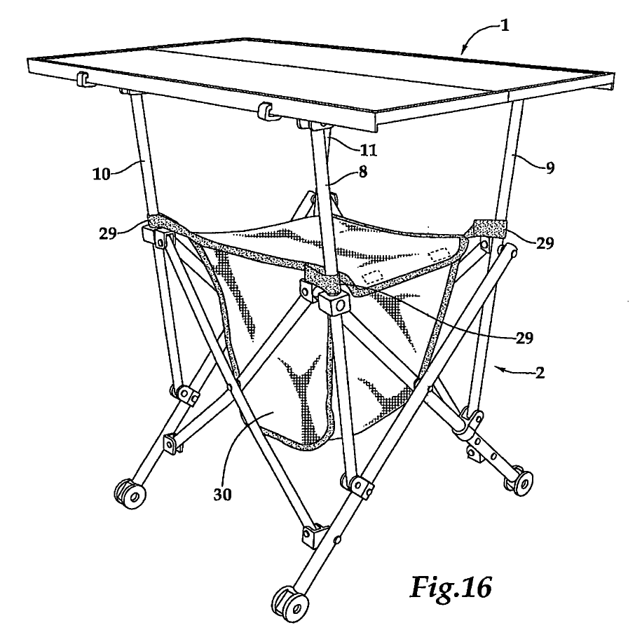

FIG. 15 is a perspective view of the present invention with the table top installed and shown with an optional hanging mesh bag. The mesh bag 28 is preferably attached with VELCRO® strips 29 that wrap around the vertical bars 8, 9, 10 and 11 of the leg assembly. The mesh bag can be used to hold snacks, beverages, reading materials, etc.

FIG. 16 is a perspective view of the present invention with the table top installed and shown with an optional waterproof bag. The waterproof bag 30 can be used to store food or beverages.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A collapsible table comprising:
(a) a table top; and
(b) a leg assembly;
wherein the table top is foldable along a center hinge;
wherein the table top comprises two halves formed by the center hinge, wherein each half of the table top comprises a side surface, and wherein each side surface of each half of the table top comprises two apertures for receiving hooks on the leg assembly;
wherein the leg assembly comprises a first horizontal arm and a second horizontal arm;
wherein the first and second horizontal arms each comprises two hooks;
wherein the apertures on the side surfaces of the table top are slightly larger than the hooks;
wherein the hooks are configured so as to fit into the apertures on the side surfaces of the table top;
wherein to install the table top on the leg assembly, the hooks are inserted into the apertures on the side surfaces of the table top, and the table top is pressed flat;
wherein the table top comprises an underside; and
wherein the first and second horizontal arms of the leg assembly fit into channels formed by ridges on the underside of the table top when the table top is pressed flat onto the leg assembly with the hooks inserted into the apertures on the table top.

2. The collapsible table of claim 1, wherein the leg assembly comprises a first vertical bar, a second vertical bar, a third vertical bar, and a fourth vertical bar;
wherein the leg assembly further comprises a first primary cross-bar, a second primary cross-bar, a third primary cross-bar, and a fourth primary cross-bar;
wherein the leg assembly further comprises a first secondary cross-bar, a second secondary cross-bar, a third secondary cross-bar, and a fourth secondary cross-bar;
wherein the first vertical bar comprises a top end and a bottom end;
wherein the first primary cross-bar comprises a bottom half;
wherein the bottom end of the first vertical bar is pivotally attached to the bottom half of the first primary cross-bar;
wherein the top end of the first vertical bar is slidably attached to the first horizontal arm;
wherein the third vertical bar comprises a top end and a bottom end;
wherein the third primary cross-bar comprises a bottom half;
wherein the bottom end of the third vertical bar is pivotally attached to the bottom half of the third primary cross-bar;
wherein the top end of the third vertical bar is slidably attached to the second horizontal arm;
wherein the second vertical bar comprises a top end and: a bottom end;
wherein the first and second primary cross-bars are pivotally attached to each other at a point;
wherein the bottom end of the second vertical bar is pivotally and slidably attached to the second primary cross-bar below the point at which the first and second primary cross-bars are pivotally attached to each other;
wherein the top end of the second vertical bar is fixedly attached to a first extension piece;
wherein the first extension piece is pivotally attached to the first horizontal arm;
wherein the fourth vertical bar comprises a top end and a bottom end;
wherein the third and fourth primary cross-bars are pivotally attached to each other at a point;
wherein the bottom end of the fourth vertical bar is pivotally and slidably attached to the fourth primary cross-bar below the point at which the third and fourth primary cross-bars are pivotally attached to each other;
wherein the top end of the fourth vertical bar is fixedly attached to a second extension piece;
wherein the second extension piece is pivotally attached to the second horizontal arm;
wherein the first and second primary cross-bars each has a bottom end and a top end;
wherein the bottom end of the first primary cross-bar comprises a foot piece;
wherein the first and second vertical bars each comprises a center;
wherein the top end of the first primary cross-bar is pivotally attached to roughly the center of the second vertical bar;
wherein the bottom end of the second primary cross-bar comprises a foot piece;
wherein the second secondary cross-bar comprises a top end;
wherein the top end of the second primary cross-bar is pivotally and slidably attached to roughly the center of the first vertical bar and pivotally attached to the top end of the second secondary cross-bar;
wherein the first and second primary cross-bars each comprises a middle third;
wherein the first and second primary cross-bars are pivotally attached to each other in the middle third of each of these two primary cross-bars;
wherein the third and fourth primary cross-bars each has a bottom end and a top end;
wherein the bottom end of the third and fourth primary cross-bars each comprises a foot piece;
wherein the third and fourth vertical bars each comprises a center;
wherein the top end of the third primary cross-bar is pivotally attached to roughly the center of the fourth vertical bar;
wherein the fourth secondary cross-bar comprises a top end;
wherein the top end of the fourth primary cross-bar is pivotally and slidably attached to roughly the center of the third vertical bar and pivotally attached to the top end of the first secondary cross-bar;
wherein the third and fourth primary cross-bars each comprises a middle third;
wherein the third and fourth primary cross-bars are pivotally attached to each other in the middle third of each of these two primary cross-bars;
wherein the first secondary cross-bar comprises a bottom end and a top end;
wherein the second secondary cross-bar further comprises a bottom end;
wherein the first primary cross-bar comprises a bottom third;
wherein the bottom end of the first secondary cross-bar is fixedly attached to the bottom third of the first primary cross-bar;
wherein the top end of the first secondary cross-bar is pivotally attached to the top end of the fourth primary cross-bar;
wherein the third primary cross-bar comprises a bottom third;
wherein the bottom end of the second secondary cross-bar is fixedly attached to the bottom third of the third primary cross-bar;
wherein the top end of the second secondary cross-bar is pivotally attached to the top end of the second primary cross-bar;
wherein the first and second secondary cross-bars each comprises a center;
wherein the first and second secondary cross-bars are pivotally attached to each other at roughly the center of each of these two secondary cross-bars;
wherein the third secondary cross-bar comprises a bottom end and a top end;
wherein the fourth secondary cross-bar further comprises a bottom end;
wherein the fourth primary cross-bar comprises a bottom third;
wherein the bottom end of the third secondary cross-bar is fixedly attached to the bottom third of the fourth primary cross-bar;
wherein the top end of the third secondary cross-bar is pivotally attached to the second vertical bar at roughly the center of the second vertical bar;
wherein the second primary cross-bar comprises a bottom third;
wherein the bottom end of the fourth secondary cross-bar is fixedly attached to the bottom third of the secondary primary cross-bar;
wherein the top end of the fourth secondary cross-bar is pivotally attached to the fourth vertical bar at roughly the center of the fourth vertical bar;
wherein the third and fourth secondary cross-bars each comprises a center; and
wherein the third and fourth secondary cross-bars are pivotally attached to each other at roughly the center of each of these two secondary cross-bars.

3. The collapsible table of claim 2, wherein each of the first and second horizontal arms comprises two ends;
wherein one end of the first horizontal arm is pivotally attached to the first extension piece at a point;
wherein the other end of the first horizontal arm is slidably attached to the top end of the first vertical bar;
wherein one end of the second horizontal arm is pivotally attached to the second extension piece at a point; and
wherein the other end of the second horizontal arm is slidably attached to the top end of the third vertical bar.

4. The collapsible table of claim 2, wherein the bottom ends of the first and third vertical bars are pivotally attached to the first and third primary cross-bars with brackets that are fixedly attached to the first and third primary cross-bars and that allow the bottom ends of the first and third vertical bars to pivot in relation to the first and third primary cross-bars.

5. The collapsible table of claim 2, wherein the bottom end of the second vertical bar is pivotally and slidably attached to the second primary cross-bar with a bracket that moves slidably up and down on the second primary cross-bar and that allows the bottom end of the second vertical bar to pivot in relation to the bracket; and
wherein the bottom end of the fourth vertical bar is pivotally and slidably attached to the fourth primary cross-bar with a bracket that moves slidably up and down on the fourth primary cross-bar and that allows the bottom end of the fourth vertical bar to pivot in relation to the bracket.

6. The collapsible table of claim 2, wherein the leg assembly further comprises a bracket that allows the top end of the second primary cross-bar to slide upward on the first vertical bar when the leg assembly is collapsed and to slide downward on the first vertical bar when the leg assembly is extended from a collapsed position and that allows the top end of the second primary cross-bar to pivot in relation to the bracket; and
wherein the leg assembly further comprises a bracket that allows the top end of the fourth primary cross-bar to slide upward on the third vertical bar when the leg assembly is collapsed and to slide downward on the third vertical bar when the leg assembly is extended from a collapsed position and that allows the top end of the fourth primary cross-bar to pivot in relation to the bracket.

7. The collapsible table of claim 3, wherein the first extension piece comprises a channel for receiving the first horizontal arm when the leg assembly is fully extended; and
wherein the second extension piece comprises a channel for receiving the second horizontal arm when the leg assembly is fully extended.

8. The collapsible table of claim 7, wherein the first and second horizontal arms each comprises a rear end;
wherein when the leg assembly is partially or fully collapsed, the rear end of each horizontal arm pivots out of the channel in the extension piece and extends upward;
wherein each channel comprises a front end;
wherein the point at which the first horizontal arm is pivotally attached to the first extension piece is located on the front end of the channel in the first extension piece; and
wherein the point at which the second horizontal arm is pivotally attached to the second extension piece is located on the front end of the channel in the second extension piece.

9. The collapsible table of claim 2, wherein the top end of the first vertical bar is connected to the first horizontal arm with a sliding bracket and the top end of the third vertical bar is connected to the second horizontal arm with a sliding bracket;
wherein the sliding brackets are constructed so that when the leg assembly is collapsed, the top end of the first vertical bar slides along the first horizontal arm from front to back and the top end of the third vertical bar slides along the second horizontal arm from front to back, and when the leg assembly is extended, the top end of the first vertical bar slides along the first horizontal arm from back to front and the top end of the third vertical bar slides along the second horizontal arm from back to front; and
wherein the sliding brackets are constructed so that the horizontal bars will not pivot out of them when the leg assembly is collapsed or extended but will remain lodged inside the sliding brackets at all times.

10. The collapsible table of claim 9, wherein the extension pieces and sliding brackets are all on a single horizontal plane when the leg assembly is fully extended; and
wherein the horizontal arms are designed so that no part of the horizontal arms extends above the horizontal plane of the extension pieces and sliding brackets when the leg assembly is fully extended.
